(19) United States
(12) Patent Application Publication
(10) Pub. No.: US 2006/0064364 A1
(43) Pub. Date: Mar. 23, 2006

(54) Method for creating and managing a portfolio of securities with a tax-enhanced index strategy

(76) Inventor: Bert Whitehead, Bloomfield Hills, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 10/943,268

(22) Filed: Sep. 17, 2004

(51) Int. Cl. G06Q 40/00

(52) U.S. Cl. 705/35

(57) ABSTRACT

A method for creating and managing a portfolio of securities with a tax-enhanced index strategy is provided. When the securities are stocks, the method includes: a) electronically accessing at least one database of stock information; b) electronically selecting individual stocks for an investment portfolio based on information in the at least one database meeting certain criteria to obtain an index of stocks; c) buying the selected stocks in an investment account; d) holding the bought stocks in the account for a period of time without any additions or deletions of stock to the investment account except in extreme circumstances; e) determining which of the held stocks has decreased in value and which of the held stocks have increased in value a predetermined amount; f) selling the stocks which have decreased in value to realize losses for tax purposes; and g) repeating steps a) and b) to reformulate the index.

### BACKGROUND OF THE INVENTION

1. Field of the Invention

This invention relates to methods for creating and managing a portfolio of securities with a tax-enhanced index strategy.

2. Background Art

Index funds are characterized by investing in all those securities that collectively form a predefined index, such as, e.g., all the different securities in the Standard & Poor's (S&P) 500, the Russell 2000, the NASDAQ 100, AMEX, DJIA, NYSE for U.S. equities, or in the TOPIX for Japanese equities. The attractiveness of these funds lies in their ability to generate a financial return that should track that of the corresponding indices at low cost.

Generally speaking, an index is defined by a predetermined universe of issues which constitute that index, e.g., common stocks of 500 large corporations which trade on United States exchanges constitute the S&P 500, as well as a proportion of the index, i.e., in terms of a weighting, attributable to each different issue therein. Illustratively, the weighting for each different security in the S&P 500 index is simply the market capitalization of that security expressed as a percentage of the total market capitalization taken across all the securities then in the index. Of course, these weights continually charge as share prices move which, in turn, changes market capitalizations both of each individual security in the index as well as that across the entire index. Other indices, such as the Value Line index, assign different, e.g. equal, weightings to each security therein.

Index funds generally fall into two distinct categories: passive funds and enhanced funds. Passive and enhanced index funds are distinguished by their adherence, or lack thereof, to the security weightings set forth in whatever index each such fund follows.

Specifically, a passive index fund merely reflects a corresponding index of interest. Specifically, a passive index fund manager will spread total fund assets across every security in the index and, for each such security, in a proportion set by the proprietor of the index, hence identically reflecting and continually tracking, to the extent possible, the performance and composition of the index. For example, a passive S&P 500 index fund manager will invest fund assets across every one of the 500 common stocks that forms the S&P 500 index and with a weighting given by this index. As the index weightings change, typically on a daily, weekly or other regular basis, positions in the individual securities in the portfolio will either be reduced or enlarged whenever necessary to accurately reflect these changes. In addition, should a given security be eliminated from the index, as a result of e.g. insufficient market capitalization or bankruptcy of its issuer or merger of its issuer into another entity, or alternatively a new security be added to the index, due to the increased capitalization of its issuer, the fund manager will then appropriately sell or buy that security to mirror the composure and weightings then existent in the index.

In sharp contrast, an enhanced index fund contains positions in the securities that constitute a corresponding index of interest but the fund manager thereof replaces the passive index weighting by his/her own weightings for each security. Risk is controlled here inasmuch as an enhanced index fund manager usually monitors a so-called “tracking error” that measures a difference between whatever financial return he/she receives relative to that of the underlying index itself, e.g., the return of S&P 500 index for an enhanced S&P 500 index fund, and trades in a fashion that maintains this error within acceptable bounds.

Financial information, particularly securities pricing, is being increasingly disseminated across an exceedingly wide geographic area in real-time electronic form. For example, this information can be obtained from, e.g.: a satellite feed, a terrestrial broadcast such as teletext or other data inserted into a broadcast television signal, data inserted into a broadcast radio signal, a dedicated computer linkage connected through the Internet or a private network to an appropriate server, or even a dial-up modem connection, established between a personal computer executing a suitable communication and/or financial program or through a dedicated terminal, and via a publicly switched telephone network, a distant server.

In order to cost-effectively manage an index fund, real-time security price information, from whatever source is chosen, generally needs to be electronically downloaded and electronically processed with resulting trading orders then being sent, via one or more electronic avenues, for appropriate execution.

An investor in a fund receives ordinary income distributions at the discretion, and depending on the management style, of the fund. Funds that churn portfolios generate more transactions than funds to do not, but the taxable distributions are dependent on the fund's activities—not the investor's.

In most funds, such as typical open-end mutual funds, net tax gains “flow through” to the inventors. In other words, an investor is saddled with whatever flow through tax gain the manager's activities have generated—and such gains are taxed at ordinary income rates. The investor has no control over these effects whatsoever, and can be in a position of having to pay tax on gains earned by the fund even where the investor has engaged in no transaction in the fund during the year. Moreover, taxable losses cannot be distributed by a fund—only taxable gains. Consequently, an investor can only receive a tax liability from the fund, not a tax benefit.

To attempt to avoid these problems, some investors with sufficiently large holdings to make it worthwhile can engage in complex tax strategies to obtain some flexibility, but those strategies are expensive to implement and not useful for smaller investors.

Alternatively, an investor can invest in a fund that attempts to limit the fund's uncontrollable tax effects. For example, a fund that engages in no selection of stocks—such as an index fund or a fund that simply invests in the largest 500 or 1000 corporations—would have little turnover from a manager buying or selling securities in order to adjust the portfolio's holdings. Even in these funds, however, there are purchases and sales by the fund to reflect redemptions or cash contributions by investors. As more investors buy into the fund, the manager buys more of the specified securities. As redemptions occur, the manager sells some of the securities to obtain cash to pay to the fund holders who are redeeming their interests in the fund. Consequently, if there was a net gain on those transactions, holders in those funds, which are generally tax flow-through funds, will receive a taxable gain, regardless of their desire.

Invariably, some securities in a fund will have depreciated while the fund overall has appreciated (or vice-versa). It is not possible for the investor in an appreciated fund to make the choice to obtain a capital loss by selling depreciated securities (and the fund itself cannot pass through losses). Conversely, it is also not possible for an investor to make the choice to obtain a capital gain by selling the appreciated assets in a fund that has depreciated overall. Those transactions in particular securities are made at the discretion of the fund manager for the fund as a whole and affect all investors in the fund.

In those few types of diversified investment vehicles where the tax effects do not flow through, the investor does not obtain any gain or loss from the appreciation or depreciation in the underlying assets. The investor can only sell part of all of his interest in the entire fund, which will either result in a gain or a loss depending on whether the fund had appreciated or depreciated as a whole relative to the investor's tax basis in the fund.

In all instances, flow through or not, the investor cannot sell some of the securities in the fund, and therefore has no ability to manage for his own benefit the various tax effects that originate from the underlying securities in the fund.

The following U.S. patent documents are related to the present invention: U.S. Pat. Nos. 5,819,238; 5,978,778; 6,061,663; 6,064,985; 6,064,986; 6,085,174; 6,188,992; 6,317,726; 6,338,047; 6,360,210; 6,484,151; 6,484,152; 6,601,044; 2001/0042037; 2002/0147671; and 2004/0039675.

Hence a need exists in the art for methods that, with only a modest amount of oversight, will effectively manage a portfolio, particularly an index fund, in a manner which is likely to consistently yield a return which substantially meets that provided by a typical passive index fund but without the complexities and costs typically associated with an enhanced index fund with tax considerations in mind. Advantageously, such methods should implement an investment vehicle which yields a return that is sufficient to garner an appreciable amount of investment capital that would otherwise flow to passive index funds. In doing so, this method should operate to maximize tax benefits.

### SUMMARY OF THE INVENTION

An object of the present invention is to provide an improved method for creating and managing a portfolio of securities with a tax-enhanced index strategy.

In carrying out the above object and other objects of the present invention, a method for creating and managing a portfolio of securities with a tax-enhanced index strategy in mind is provided. The method includes: a) electronically accessing at least one database of security information; b) electronically selecting individual securities for an investment portfolio based on information in the at least one database meeting certain criteria to obtain an index of securities; c) buying the selected securities in an investment account; d) holding the bought securities in the account for a period of time without any additions or deletions of securities to the investment account except in extreme circumstances; e) determining which of the held securities has decreased in value and which of the held securities have increased in value a predetermined amount; f) selling the securities which have decreased in value to realize losses for tax purposes; g) repeating steps a) and b) to reformulate the index; h) transferring the securities which have increased in value the predetermined amount from the investment account to a cultivating account; i) selling the securities which have neither decreased in value nor increased in value the predetermined amount; and j) buying the securities of the reformulated index in the investment account.

The securities may be stocks and/or bonds.

The criteria may include selecting stocks of companies with database records indicating that the companies are within at least one major stock index.

The index of stocks may imitate a plurality of major stock indices without buying all of the stocks of the indices.

The stocks in step c) may be bought in equal amounts.

The method may further include buying at least one ETF to ensure that the portfolio is substantially fully invested.

The method may further include selling the at least one ETF to obtain cash, wherein step j) utilizes the cash to obtain the stocks of the reformulated index.

Steps f) and i) may be performed to obtain cash, and step j) may utilize the cash to obtain the securities of the reformulated index.

The method may further include maintaining a database of information representing prices of the securities of steps c), f), i) and j) for tax purposes.

A period of time between performance of steps c) and j) may be approximately one year.

A period of time between performance of steps f) and j) may be more than 31 days.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a schematic view of a programmed computer capable of communicating over the Internet with a computer having a database containing stock information and capable of performing at least one step of a method of the present invention;

FIG. 2 is a generalized block diagram flow chart illustrating one embodiment of the invention; and

FIG. 3 is a more detailed block diagram flow chart illustrating various method steps of one embodiment of the method.

### DETAILED DESCRIPTION OF THE PREFERRED EMBODIMENTS

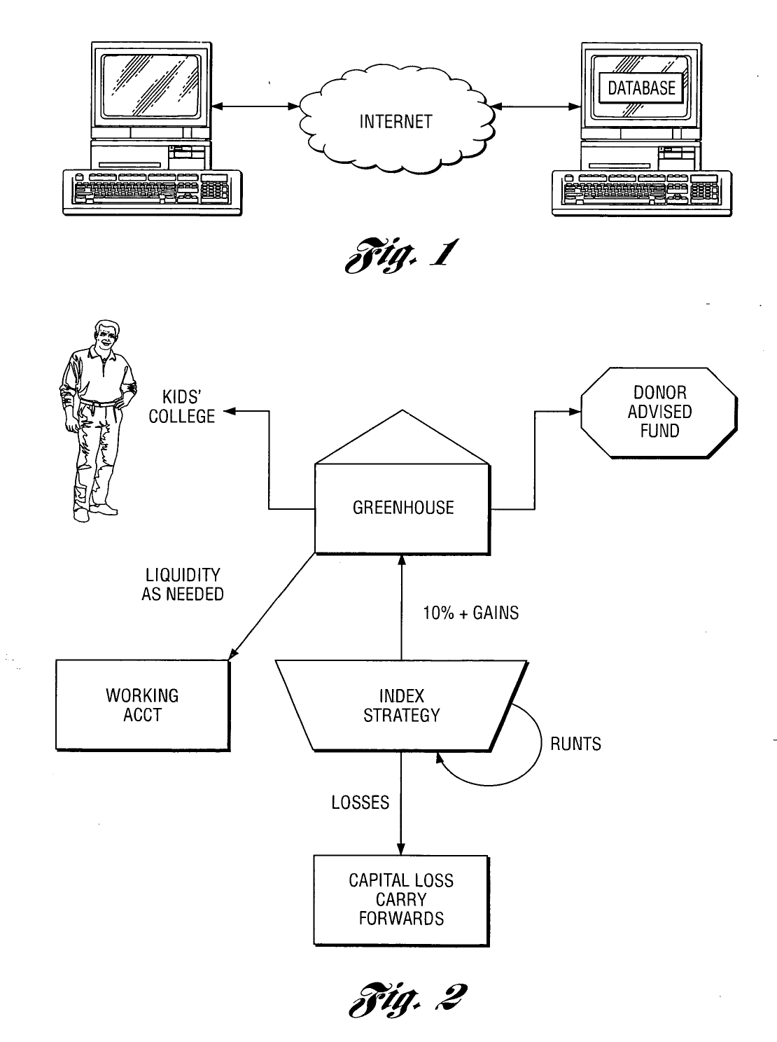

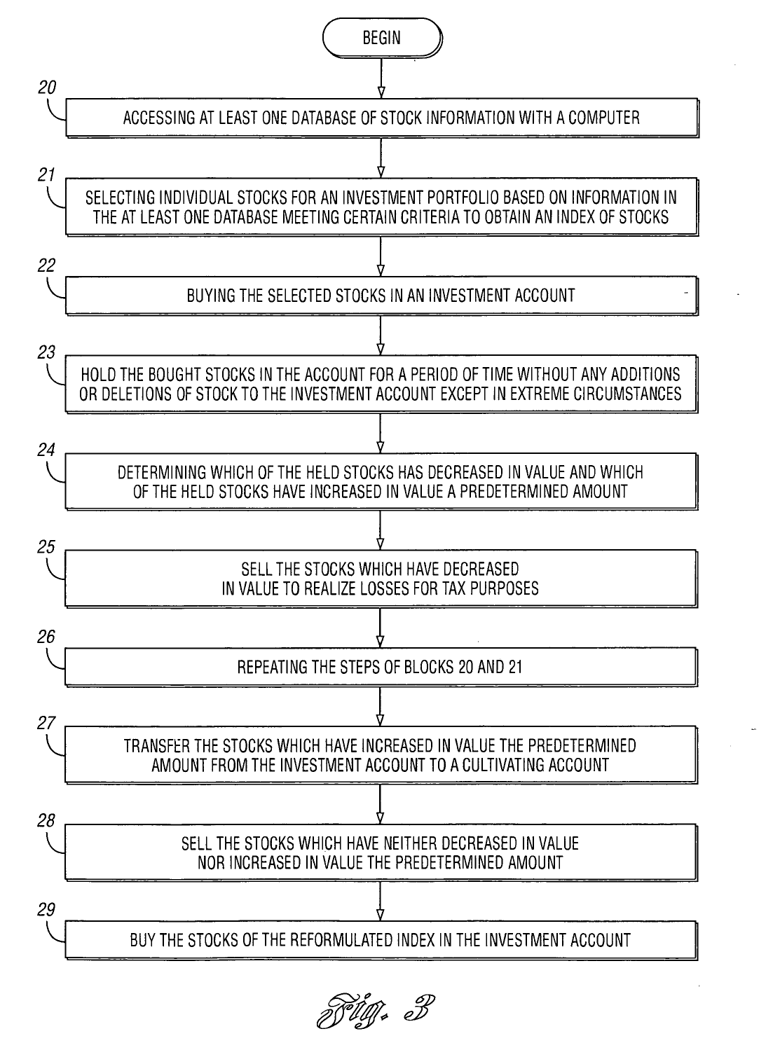

In one embodiment of the present invention, and as indicated in FIGS. 1 and 2 (i.e., the Index Strategy block), a computer programmed with a program electronically picks 50 large cap domestic stocks which in aggregate mimic the three major US indices, the Dow, S&P 500, and Nasdaq 100 over the Internet. This new index enables an advisor to provide clients with an indexed approach to investing using separate account management, without buying all the stocks in the index. The new index is reset or reformulated each year to take into account changing capitalizations and index composition.

The formula for picking the stocks is to use the politically acceptable 29 stocks in the Dow, the largest 10 stocks selected from the Nasdaq 100 and then the largest 11 stocks by market capitalization which are in the S&P 500, but have not been previously selected.

The aggregate performance of stocks selected in this manner typically neither exceeds nor lags the three major indices in any year.

The strategy preferably requires buying the individual stocks in each client's account in early December of each year in equal amounts (i.e., not weighted by capitalization).

No additional contributions from a client are permitted during the year. Additional investments are dollar-cost-averaged into DIA (60%), QQQ (20%), and SPY (20%) in a separate account. Transaction costs may be minimized by investing in a single ETF each month in sequential order of DIA, QQQ, DIA, SPY, DIA to achieve the desired allocation.

No changes are made during the year in the portfolio, except in extreme circumstances (e.g. a stock such as Worldcom could be sold at three cents a share to realize losses while it was still marketable). Dividends are invested quarterly in the DIA ETF, so that 98% of the portfolio remains invested at all times.

In late October, prior to October 31, all the stocks which are at a loss (the “losers”) are sold to realize the losses for tax purposes. The cash is invested in DIA ETF to assure that the fund is substantially fully invested (i.e., 98%).

The index is reformulated in late November each year, using the above formula.

In early December, all the “winners” (i.e., stocks which have increased more than 10% since purchase) are transferred to a “Greenhouse” or cultivating account, as shown in FIG. 2. At that time, all the “runts” (i.e., stocks which were not losers or winners) are sold. This cash may be invested in a DIA ETF.

The DIA ETFs are sold and that cash, combined with the cash from sale of the runts (i.e., if not invested in DIA ETFs), and new cash provided by the client, is invested in the next year's index in the first part of December and put into the client's account.

The winners in the greenhouse account, which are all long-term capital gains, may be used for tax advantaged charitable contributions (i.e., Donor Advised Fund), gifting to children for college tuition (thus being taxed at their rate), or later liquidation for cash flow with the gain offset by accumulated capital losses.

Capital losses are carried forward to offset future gains in real estate, sale of business, or other stock market gains, etc. (i.e., Capital Loss Carry Forwards).

Provision is made to keep track of the basis of all transactions during the year as well as basis numbers of each block of stocks in the greenhouse.

In summary, the present invention provides an improved method for creating and managing a portfolio of securities with a tax-enhanced index strategy.

The method for creating and managing a portfolio of securities with a tax-enhanced index strategy is more specifically described now with reference to FIG. 3. The method typically includes, at block 20, accessing at least one database of stock information with a computer.

At block 21, individual stocks are selected for an investment portfolio based on information in the at least one database meeting certain criteria to obtain an index of stocks.

At block 22, the selected stocks are bought in an investment account.

At block 23, the bought stocks are held in the account for a period of time without any additions or deletions of stock to the investment account except in extreme circumstances.

At block 24, it is determined which of the held stocks has decreased in value and which of the held stocks have increased in value a predetermined amount.

At block 25, the stocks which have decreased in value are sold to realize losses for tax purposes.

At block 26, the steps of blocks 20 and 21 are repeated to reformulate the index.

At block 27, the stocks which have increased in value the predetermined amount are transferred from the investment account to a cultivating (i.e., “Greenhouse”) account.

At block 28, the stocks which have neither decreased in value nor increased in value the predetermined amount are sold.

At block 29, the stocks of the reformulated index are bought in the investment account.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for creating and managing a portfolio of securities with a tax-enhanced index strategy, the method comprising:
a) electronically accessing at least one database of security information;
b) electronically selecting individual securities for an investment portfolio based on information in the at least one database meeting certain criteria to obtain an index of securities;
c) buying the selected securities in an investment account;
d) holding the bought securities in the account for a period of time without any additions or deletions of securities to the investment account except in extreme circumstances;
e) determining which of the held securities has decreased in value and which of the held securities have increased in value a predetermined amount;
f) selling the securities which have decreased in value to realize losses for tax purposes;
g) repeating steps a) and b) to reformulate the index;
h) transferring the securities which have increased in value the predetermined amount from the investment account to a cultivating account;
i) selling the securities which have neither decreased in value nor increased in value the predetermined amount; and
j) buying the securities of the reformulated index in the investment account.

2. The method as claimed in claim 1, wherein the securities are stocks and wherein the criteria includes selecting stocks of companies with database records indicating that the companies are within at least one major stock index.

3. The method as claimed in claim 1, wherein the securities are stocks and wherein the index of stocks imitates a plurality of major stock indices without buying all of the stocks of the indices.

4. The method as claimed in claim 2, wherein the stocks in step c) are bought in equal amounts.

5. The method as claimed in claim 2, further comprising buying at least one ETF to ensure that the portfolio is substantially fully invested.

6. The method as claimed in claim 5, further comprising selling the at least one ETF to obtain cash and wherein step j) utilizes the cash to obtain the stocks of the reformulated index.

7. The method as claimed in claim 1, wherein steps f) and i) are performed to obtain cash and wherein step j) utilizes the cash to obtain the securities of the reformulated index.

8. The method as claimed in claim 1, further comprising maintaining a database of information representing prices of the securities of steps c), f), i) and j) for tax purposes.

9. The method as claimed in claim 1, wherein a period of time between performance of steps c) and j) is approximately one year.

10. The method as claimed in claim 1 wherein a period of time between performance of steps f) and j) is more than 31 days.
